(19) United States
(12) Patent Application Publication
(10) Pub. No.: US 2006/0214004 A1
(43) Pub. Date: Sep. 28, 2006

(54) Person-verifying medium using a luminous body, and process for producing the same

(75) Inventors: Koichi Kubo, Nagasaki (JP); Mizuki Yamahira, Nagasaki (JP)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(73) Assignee: Tsujiden Co., Ltd., Tokyo (JP)

(21) Appl. No.: 11/198,671

(22) Filed: Aug. 5, 2005

(30) Foreign Application Priority Data
Mar. 24, 2005 (JP) 2005-86444

(51) Int. Cl. G06K 19/06; G06K 5/00

(52) U.S. Cl. 235/491; 235/380

(57) ABSTRACT

Provided is a person-verifying medium wherein authenticity judgment is easy and forgery or alteration is difficult. Provided is a person-verifying medium wherein there is provided, on a substrate, a luminous body in a dot pattern and being formed by a material which does not emit light under visible rays but emits light under ultraviolet rays. The luminous body layer can be formed by vapor-depositing a low-molecular-weight compound luminous body or by forming a film of a polymer compound luminous body by inkjet. Alternatively, the luminous body layer is irradiated with a laser ray so as to be partially deteriorated, thereby forming a luminous body in a dot pattern. The luminous body layer in a dot pattern is preferably provided within the area surrounded by banks. It is preferable that the banks have water repellency and the area surrounded by banks is hydrophilic. The banks preferably have a form of lattice on asymmetric matrix. There is provided a highly-reflecting metal film beneath the luminous body layer, and thereby making it possible to increase the light emission.

### FIELD OF THE INVENTION

The present invention relates to a person-verifying medium wherein there is formed a luminous body layer in a dot pattern for preventing forgery or alteration and for determining authenticity, and a process for producing the same.

### BACKGROUND OF THE INVENTION

Hitherto, there has been known a certificate with a photograph of a person's face for verifying the person holding the certificate, such as an employee certificate or a membership card. The certificate needs to be prevented from being wrongfully used, and the certificate is desired not to be forged or altered with ease and to be easily determined as to its authenticity. An example of the technique for coping with the desires is a technique of applying a hologram or a seal onto a surface of a certificate, which has been made practicable for cash cards and the like. However, in the case of applying a hologram or a seal onto a certificate for which a photograph of a person's face, personal data and others are required, there is caused an inconvenience that a design on the surface of the certificate is restricted by the amount of the area thereof. Moreover, there is a drawback that the hologram or seal can be forged or altered with relative ease.

For the prevention of wrongful use, the following are desired: determination of authenticity is easy; forgery or alteration thereof is difficult; and the application of a means for preventing the wrongful use does not restrict design of the person-verifying medium. However, a medium satisfying all of these requirements has not been developed.

An example of the means for preventing forgery or alteration is a technique of forming a film of an inorganic fluorescent pigment or an organic fluorescent dye, irradiate light having a specific wavelength, and judging the authenticity by finding whether a light is emitted or not. However, the technique is not a complete means for preventing such forgery or alteration since a material which emits light by a specific wavelength can be relatively easily prepared. Moreover, with only the existence or absence of emitted light, only the authenticity can be judged, and thus, it is impossible to verify the individual person. For example, Japanese Patent Laid-open Publication No. 2002-283777 describes a person-verifying medium comprising a substrate, an image layer formed on the substrate, an ultraviolet absorbing layer formed on the image layer, and a tally seal pattern arranged between the image layer and the substrate or between the image layer and the ultraviolet absorbing layer. Japanese patent Laid-open Publication No. 2001-88411 describes a person-verifying medium and a method of forming an image, wherein a color image is formed using at least three color inks each containing a visible coloring matter and an invisible coloring matter which gives a color different from that of the visible color matter by excited light. Japanese patent Laid-open Publication No. 2000-225774 describes an image forming article for verification, wherein: a yellow-colored ink layer, a magenta-colored ink layer and a cyan-colored ink layer are arranged side by side on the upper surface of a substrate in a band form, so that these colored ink layers constitute a color ink layer region; and a red fluorescent ink layer, which emits red light by the irradiation thereof with ultraviolet rays, a green fluorescent ink layer, which emits green light thereby, and a blue fluorescent ink layer, which emits blue light thereby, are arranged side by side in a region continuous to the color ink layer region on the upper surface of the strip-shaped substrate, so that these fluorescent ink layers constitute a fluorescent color ink layer region.

In the invention described in Japanese patent Laid-open Publication No. 2002-283777, the tally seal is made of aluminous body so as to determine the authenticity. However, according to this method, only the judgment of an authenticity can be verified by the presence or absence of light emission, and thus, the method has a problem that personal data, such as person's status and license certificate, must be attached by another method. In the invention described in Japanese patent Laid-open Publication No. 2001-88411, a luminous body is irradiated with excited light to emit light from an image. However, the invention has a problem that personal data can be watched by a third person and the image can be copied since a source of excitation and luminous bodies are generally available. In the same manner as the invention in Japanese patent Laid-open Publication No. 2001-88411, the invention described in Japanese patent Laid-open Publication No. 2000-225774 has a problem that the forgery or alteration is easy in the case that the image is made by a luminous body.

The present invention has been made in light of the above-mentioned situation. In another words, a first object of the invention is to provide a person-verifying medium in which authenticity is easily determined, and is not easily forged or altered. A second object of the invention is to provide a process for producing, with ease, a person-verifying medium which is not easily forged or altered.

### SUMMARY OF THE INVENTION

The gist of the present invention is a person-verifying medium, wherein there is arranged a luminous body layer in a dot pattern and being formed by a material which does not emit light under visible light but emits light under ultraviolet rays on a substrate, such as a plastic substrate, a metal substrate, a glass substrate and the like. This luminous body layer in a dot pattern can be arranged by vapor-deposition of a low-molecular-weight compound luminous body or by dissolving a polymer compound luminous body in a solvent and then inkjet-printing this solution. At this time, the luminous body layer in a dot pattern is preferably arranged in an area surrounded by a bank. The bank herein means a dike inside which the luminous body is applied or formed. Accordingly, the luminous body layer in a dot pattern is formed in the area surrounded by the bank. The thickness of the bank is preferably 0-10 μm larger than that of the luminous body layer in a dot pattern. The bank itself is preferably made water repellent. Additionally, the area where the luminous body layer in a dot pattern and being surrounded by the bank is formed is preferably made hydrophilic. The bank is preferably formed into a lattice form or an asymmetric matrix. At this time, the shape of the bank is preferably rectangular or circular. The width of the top of the bank is preferably set in the range of 1 to 5 μm. The inclination angle of the bank is preferably set in the range of 10 to 80 degrees. There may be arranged a protective film layer on the top of the luminous body layer an organic film, an inorganic film or a laminated film made of an organic film and an inorganic film.

The bank can be plasma-treated with a fluorine-based gas to impart water repellency to the bank, and the area surrounded by the bank can be subjected to irradiation with ultraviolet rays, ultraviolet ray/ozone treatment, or oxygen plasma treatment to impart hydrophilicity to the area. By making the area surrounded by the bank hydrophilic and making the bank itself water repellent, liquid droplets, at the time of inkjet-printing, are precisely received within the area surrounded by the bank, so that a luminous body layer in a dot pattern and having a high precision can be formed. For the formation of the bank, photolithography or sandblasting can be used.

At the time of forming the luminous body layer in a dot pattern of the luminous body on a substrate such as a plastic substrate, a metal substrate or a glass substrate and the like, a bank is formed into a lattice form or an asymmetric matrix form on the substrate; the bank is plasma-treated with a fluorine-based gas to impart water repellency to the bank; the area surrounded by the bank is subjected to irradiation with ultraviolet rays, ultraviolet ray/ozone treatment, or oxygen plasma treatment to impart hydrophilicity to the area; and is inkjet-printed within a solution of a polymer compound luminous body making it possible to provide the hydrophilic area surrounded by the bank, thereby the dot pattern.

The bank can be formed by photolithography using a polyimide-based photoresist. A highly-reflecting metal film can be formed beneath the luminous body layer. This highly-reflecting metal film is preferably a film made of a metal selected from aluminum, silver, gold and chromium. The highly-reflecting metal film makes it possible that when ultraviolet rays are irradiated onto the luminous body layer, the intensity of light therefrom is made high. The highly-reflecting metal film can be formed by vacuum vapor deposition, sputtering, printing and the like of a metal selected from aluminum, silver, gold and chromium.

The dot pattern can be formed by irradiating with laser rays the luminous body formed on the substrate and thereby deteriorating the luminous body partially.

By using an organic luminous body, a pattern of images, dots, or barcodes is formed, with a high precision, on a substrate by vacuum vapor deposition or by a wet film-forming method such as inkjet-printing; by means of an information-reading device using an ultraviolet ray source, the pattern is excited or light is emitted from the pattern, and then a position where the light is emitted or the spectrum of the emitted light is read, thereby carrying out verification. The feature of the invention is that a luminous body is arranged in a lattice form or matrix form without using any numeral, bar code, or figure and a person is verified based on the dot pattern. In the case of using, in particular, a polymer compound luminous body, a luminous body layer in a dot pattern can be formed by dissolving the polymer compound luminous body in a solvent and then applying fine liquid droplets by inkjet-printing. By using a bank, the fine luminous body are formed into a film with a high precision and the forgery or alternation becomes difficult.

The present invention is an invention wherein a highly-fine dot pattern luminous layer is formed on a substrate by vapor deposition of a low-molecular-weight compound luminous body or by inkjet-printing of a polymer compound luminous body, and is an invention wherein person-verification is carried out based on a highly-fine dot pattern. In the case when a bank is provided and the luminous body layer is provided within the area surrounded by the bank after selecting arbitrary points, simply 2¹⁰⁰ patterns of information can be secured in a very small area. The luminous body layer in a dot pattern is excited with ultraviolet rays so as to emit light. The light is detected as pattern information or spectrum information, thereby conducting an authenticity judgment as well as verification of a person. The detection of the pattern information and the spectrum of the luminous body improves the precision of the authenticity judgment, and there is obtained a person-verifying medium which is not easily forged or altered. When this method is used, the present invention can be widely applied to not only verification cards but also bank note, gift certificates, credit cards and the like. Many polymer compound luminous bodies are transparent when they are in the state of a thin film; therefore, the present invention has a feature that the card design thereof is less restricted than conventional one using a hologram or magnetization.

### BRIEF DESCRIPTION OF THE DRAWINGS

FIG. 1 is a view illustrating an example of the person-verifying medium of the invention;

FIG. 2 is a view illustrating an example of a dot pattern;

FIG. 3 is a view illustrating a construction of the person-verifying medium of the invention;

FIG. 4 is a view illustrating a construction of the person-verifying medium of the invention, using a reflecting metal film;

FIG. 5 is a construction of the person-verifying medium of the invention, using a reflecting metal film and a bank;

FIG. 6 is a construction of the person-verifying medium of the invention, using a plastic substrate as a protective layer;

FIG. 7 is a construction of the person-verifying medium of the invention, using a laminated film composed of an organic film and an inorganic film as a protective layer;

FIG. 8 is a construction of the person-verifying medium of the invention, using a laminated film composed of an inorganic film and an organic film as a protective layer;

FIG. 9 is a sectional view illustrating a bank;

FIG. 10 is a plan view illustrating the bank;

FIG. 11 is a chart showing an emission spectrum of a luminous body; and

FIG. 12 is a flowchart for recognizing the pattern of a person-verifying medium.

### DETAILED DESCRIPTION

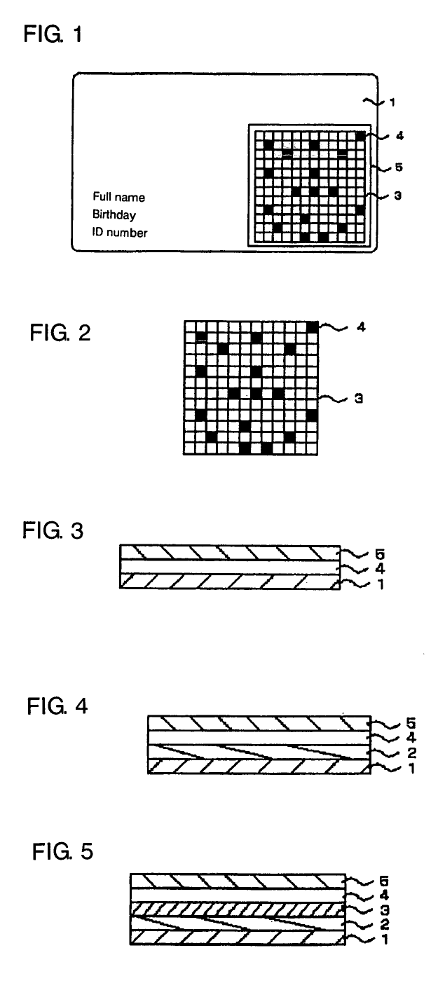

The present invention will be described based on embodiments thereof hereinafter. However, the invention is not limited thereto. An embodiment of the person-verifying medium of the invention is a person-verifying medium wherein there is formed on a substrate a luminous body layer in a dot pattern and being made of a low-molecular-weight compound luminous body or a polymer compound luminous body which does not emit light under visible rays but emits light under ultraviolet rays, and wherein this luminous body layer in a dot pattern is protected with a single-layered film or laminated film made of an inorganic film or an organic film and the like. A transparent plastic film may be stuck, to form a protective film, onto the substrate on which the luminous body layer in a dot pattern is formed. An example of the person-verifying medium is illustrated in FIG. 1. In another words, this is a person-verifying medium in a card-like form on which person's full name, birthday, ID number, and so on are recorded and a luminous layer in a dot pattern which assures person-verification is formed. The luminous layer in a dot pattern cannot be read under visible rays, but can be read under ultraviolet rays. Based on this light emission pattern, the judgment of authenticity can be conducted and further the person is verified.

The point of the person-verifying medium of the embodiment of the invention is that: on a substrate is formed a luminous body layer in a dot pattern and being made of a low-molecular-weight compound luminous body or a polymer compound luminous body which does not emit light under visible rays but emits light under ultraviolet rays. In order to pattern the low-molecular-weight compound luminous body, there is used a method of using a shadow mask made of a metal or a mesh to vapor-deposit the low-molecular-weight compound luminous body. The patterning with the shadow mask is a method which is ordinarily performed for low-molecular-weight compound organic EL. This method makes highly fine patterning possible. In order to form a different dot pattern, the shadow mask is replaced. In order to make the luminous body layer in a dot pattern and being made of the polymer compound luminous body, there is used a method of dissolving the polymer compound luminous body in a solvent, and applying the solution by IJP (inkjet printing), screen printing, gravure coating, reverse coating, die coating, wire bar coating, or the like. When a highly fine pattern, in particular, is needed, it is preferred to perform inkjet printing.

IJP is capable of forming a film from fine liquid droplets in the order of picoliter, and is characterized by that a highly fine pattern is obtained. In order to form the pattern precisely, it is advisable to make, on the substrate, a bank of an organic film and the like having water repellency, such as a polyimide film, or some other film, and then apply and form the luminous body within an area surrounded by the bank. The water-repellent effect of the bank can be improved by plasma treatment with a fluorine-based gas and the like. The bank is in a lattice form or an asymmetric matrix form, and preferably has a rectangular or circular shape. The luminous body is formed in the area surrounded by the bank.

The area surrounded by the bank is preferably subjected to irradiation with ultraviolet rays, ultraviolet ray/ozone treatment, or oxygen plasma treatment so as to impart hydrophilicity to the area. By making the area surrounded by the bank hydrophilic and making the bank itself water repellent, liquid droplets, at the time of being inkjet-printed, are precisely received within the area surrounded by the bank, so that a pattern having a high precision can be formed. For the formation of the bank, photolithography or sandblasting can be used.

The shape of the bank is determined based on the size of the luminous area, the thickness of the luminous body layer to be formed, the inclination angle of the bank, and other factors. The thickness of the bank is preferably not less than the thickness of the luminous body layer and not more than 10 μm. If the bank is thinner than the luminous body layer, the applied luminous body material is formed into a film in the state that the material is forced outside the bank. As a result, the precision of the film falls. If the bank is too thick, edges of the bank are not easily treated for water repellency. The width of the top of the bank is preferably from 1 to 3 μm, and the inclination angle thereof is preferably from 10 to 80 degrees. The inclination angle can be adjusted by changing the baking time and temperature for the photolithographic working, or other factors. The size of the bank is preferably made larger than the minimum size of the liquid droplets applied during the inkjet printing, and the shape thereof is preferably rectangular or circular. The bank is formed, for example, in a matrix form, as illustrated in FIG. 2. In FIG. 2, dots painted in black are each made of the luminous body.

The material for forming the bank may be a photosensitive composition composed of a naphtoquinonediazide photosensitive agent and a polyimide resin, Novolak resin, acrylic acid based resin or glutarimide resin. As for the method for forming the bank, a photolithography method or a method of curing an optically curable resin by electron beams is used. The resin which can be used may be a resin for film-forming patterning that is generally used. The bank-forming method is conveniently photolithography or sandblasting.

The bank can be formed by photolithography or sandblasting. Specifically, the bank-forming material is evenly applied by spin coating or the like, patterned in a photolithographic step, and then etched to form the bank precisely. In the photolithography, photosensitive polyimide is applied, and irradiated with light through a photo-mask which is consistent with the pattern of the bank. The region irradiated with the light undergoes chemical reaction by the light. This is developed to remove the polyimide in the region irradiated with the light, whereby the bank is formed.

The bank is subjected to water repellency treatment, and subsequently a luminous body is applied onto the substrate by inkjet printing, printing or the like, so as to form a luminous body layer. At this time, the inside of the bank is hydrophilic and the top of the bank is water repellent; accordingly, the luminous body applied incorrectly onto the top of the bank is led to the inside of the area surrounded by the bank because of the water repellency of the bank, so that the luminous body is received only in the area surrounded by the bank. In the absence of the bank, the accuracy of the location where the luminous body is applied is as large as ±several tens of micrometers. However, the formation of the bank causes the location accuracy to be improved into ±several micrometers. When the luminous body can be applied with a high precision, the precision of the verification is improved. Additionally, by making the pattern minute, forgery or alteration of the medium becomes significantly difficult.

The polymer compound luminous body can be formed into a luminous layer in a highly-fine dot pattern on the substrate by inkjet printing. In the case of using inkjet printing, the patterning accuracy of the dot pattern is about ±15 μm. In case of inkjet printing, minute liquid droplets in the order of picoliter can be applied. In the case that several liquid droplets in the order of picoliter are dropped, a luminous area of about several square micrometers can be obtained. In the case of forming a pattern which makes it possible to form a dot pattern easily and further emits light at random sites, selecting any dots and painting the dots, 2¹⁰⁰ patterns of information can simply be obtained within a very small area.

Examples of the system for the inkjet printing include an electrification control-system, a pressure-applying vibration system, an electromechanical conversion system, an electrothermal conversion system, an electrostatic absorption system. For example, the electromechanical conversion system is a system using a property that a piezoelectric element receives electric signal pulses so as to deform, and is a system wherein the piezoelectric element deforms to apply pressure to liquid material, thereby pushing out the material from nozzles to expel the material. The amount of the jetted-out material is decided in accordance with the size of the bank, the thickness of the luminous body layer to be formed, the concentration of the material, and other factors.

The bank is treated with gas plasma generated by electric-field-excitation, so as to be made hydrophilic. The gas used in the treatment for hydrophilicity may be oxygen, nitrogen, or a mixed gas of oxygen and nitrogen. Active oxygen radicals in the plasma cause the decomposition and removal of organic materials on the surface of the substrate, thereby making the bank hydrophilic. On the other hand, the treatment for water repellency is a treatment with fluoride gas plasma. Fluorine is bonded to the resin surface on the bank to impart water repellency to the top of the bank. The treatment for hydrophilicity and the treatment for water repellency may be continuously conducted. The fluoride gas may be a fluorine-substituted methane gas such as CF₄, CHF₃, CH₂F₂ or CH₃F, a fluorine-substituted ethane gas such as CH₃—CF₃ or CHF₂—CHF₂, or a gas wherein fluorine is bonded to a heteroatom, such as NFH₂ or NF₂H. In the plasma, the gas reacts with the surface molecules of the bank, so that the bank surface is fluorinated.

It is effective for a glass substrate to conduct the treatment for hydrophilicity and the treatment for water repellency simultaneously, but in the case of a resin substrate, the substrate or the bank thereon cannot be selectively subjected to the treatment for hydrophilicity/the treatment for water repellency. Accordingly, a material having a higher water repellency than the resin substrate (an example of the material being polyimide which has water repellency beforehand) is used as the material for the bank. Plasma can be generated in either of a vacuum and the atmosphere. In the case of using vacuum plasma, conditions for generating oxygen plasma are as follows: an RF electric power of 50 W, an oxygen gas flow rate of 50 sccm, and a vacuum degree of several pascals during the treatment. Thereafter, CF₄ is introduced in the vacuum, and under the same conditions the water repellency treatment can be conduced. The time for each of the treatments is one minute. The wettability of the area surrounded by the bank at this time is from 2 to 5 degrees, and that of the bank is from 70 to 80 degrees. The wettability means the contact angle. The principle of the measurement thereof is as follows: a liquid sample is expelled from a needle tip, so as to be brought into contact with a solid sample. The liquid is transferred onto the solid, thereby forming a liquid droplet. In a measuring method of the device (three-point clicking method), three coordinates of three points at the left end (L), the right end (R), and the top (T) of the liquid droplet are obtained. From the decided three points L, R and T, the diameter (2r) of the liquid droplet and the height (h) thereof are obtained. The contact angle θ is calculated from the following equation:
θ=2 tan⁻¹(h/r)

In order to find out a bank structure such that an ink jetted-out from an inkjet printer does not leak from the inside of the bank on the substrate, the wettability of the ink onto the substrate has been investigated. When the contact angle θ of the ink onto the bank becomes 90 degrees or more, the ink landed incorrectly onto the edge of the bank wets and extends on the bank. The inclination angle of the bank edge is also an important parameter for putting liquid droplets precisely inside the bank. In the case that the inclination angle of the bank edge is set to 45 degrees or lower, liquid droplets remain at the edge even if the edge is treated for water repellency when the liquid droplets go astray so as to land onto the inclined region. As a result, the possibility that the droplets flow inside the bank is low, so that a luminous body layer is formed in the state that the layer is forced out from the bank. When the angle is from 10 to 80 degrees, preferably from 45 to 80 degrees, the liquid droplets landed onto the edge also flow from the edge to the insides of the bank by water repellent effect. If the angle is 80 degrees or higher, the landed liquid droplets remain on the bank since the edge is hardly inclined.

The light emission sites can be patterned by applying the luminous body onto the entire area of the substrate and then deteriorating the luminous body partially. The method for deteriorating the luminous body is a method of causing the ablation with an ultraviolet ray source such as a YAG laser or an excimer laser. The use of this method can cause selective light attenuation of the luminous body. Specifically, a laser or the like is used to deteriorate the luminous body, thereby causing selective light attenuation or optical quenching of the luminous body. The luminous body is selectively irradiated with laser rays, whereby light from the irradiated region can be attenuated. In the case of using the ultraviolet ray source, a laser having a wavelength of about 250 to 400 nm is optimal. Specifically, an ultraviolet ray source such as a broad band ultraviolet ray source having wavelengths of about 250 to 400 nm is preferably used as the light source. The luminous body is denatured to deteriorate the luminous capability thereof, thereby attenuating light therefrom. In the case of using an inorganic luminous body as the luminous body used at this time, light from the material is not easily attenuated even if the time for the irradiation with ultraviolet rays is set to several hours, because the inorganic material is strong against ultraviolet rays. However, a low-molecular-weight or polymer luminous body material is easily deteriorated with ultraviolet rays so as to cause the light attenuation of the material.

Since the luminous body is deteriorated with water or oxygen also, it is preferred to protect the luminous body with an inorganic film, an organic film, or a laminated film composed of inorganic and organic films. The luminous body can be protected by sticking a plastic film onto the substrate on which the luminous body is formed by an adhesive or the like. An inorganic film, an organic film or the like is formed, as an anchor coat for the luminous body, whereby the luminous body can be more restrained from being deteriorated. This organic film may be a silicone type, acrylic type, or epoxy type plastic film. The protective film or anchor coat maybe made of a mixture of organic and inorganic materials, for example, acrylic silicone. The inorganic film may be a film made of a metal oxide and a metal nitride, such as aluminum nitride, aluminum oxide, silicon nitride, titanium oxide, silicon oxide or silicon oxynitride.

The inorganic film is not desirable since it easily cracks and is weak against bending. It is preferred to protect the luminous body with a laminated film composed of inorganic and organic films. In this case, the organic film is used as a stress-relieving layer, and the application of this film makes it possible to prevent the inorganic film from being cracked by the stress of the inorganic film.

The luminous intensity of the luminous body can be made remarkably high by forming a film made of a highly reflecting metal such as aluminum, silver, gold or chromium beneath the luminous body by vacuum vapor deposition, sputtering, printing or the like before the step of forming the luminous body. Moreover, it is preferred to form the film of the highly reflecting metal before the formation of the bank.

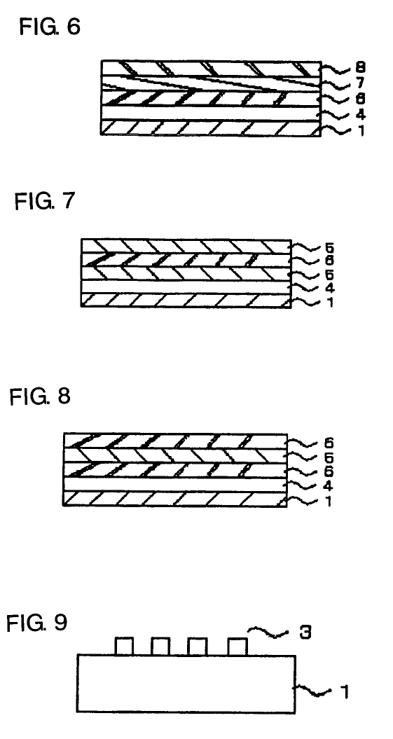

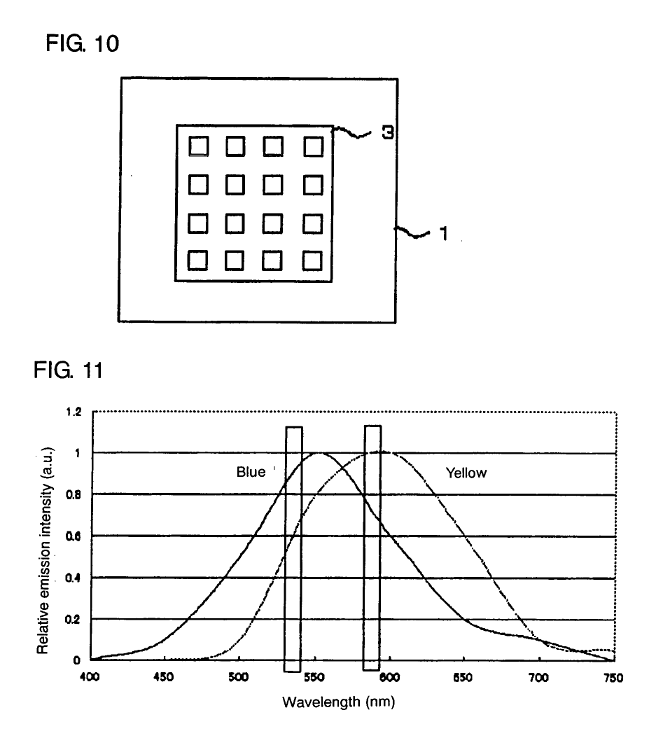

The configuration of the person-verifying medium of the invention is described with reference to the drawings. FIG. 3 illustrates a basic configuration of the person-verifying medium, which is a configuration wherein a luminous body layer 4 is formed on a substrate 1 and an organic film 5 is formed on the layer 4 in order to protect the layer 4. FIG. 4 illustrates the configuration of an example of the person-verifying medium on which a metal reflecting film is formed, which is a configuration wherein a luminous body layer 4 and a protecting organic film 5 are formed over a substrate and a metal film 2 is formed beneath the luminous body layer 4. FIG. 5 illustrates an embodiment wherein a bank 3 and a metal film 2 are formed. FIG. 6 illustrates an embodiment wherein a plastic film 8 is formed as a protecting layer through an adhesive layer 7 over an inorganic film 6. FIG. 7 illustrates an embodiment using a laminated film composed of an organic film 5 and an inorganic film 6 as a protective layer. FIG. 8 illustrates an embodiment using a laminated film composed of an inorganic film 6 and an organic film 5 as a protective layer. As described above, the person-verifying medium of the invention can be modified into various configurations.

Examples of a polymer compound luminous body out of the luminous bodies include polysilane derivatives, poly(para-phenylenevinylene) derivatives, polythiophene derivatives, poly(para-phenylene) derivatives, polyacetylene derivatives, polyvinylcarbazole derivatives, polyfluorenone derivatives, polyspiro derivatives, polyfluorene derivatives, polyquinoxaline derivatives, and copolymers thereof. Additives such as a doping agent may be added to the luminous body layer in order to improve the luminous efficiency thereof, change the luminous wavelength, and attain other purposes. Examples of the doping agent include perylene derivatives, coumalin derivatives, rubrene derivatives, quinacridon derivatives, squarylium derivatives, polyphrin derivatives, styryl colorants, tetracene derivatives, pyrazoline derivatives, decacyclene, phenoxazone, quinoxaline derivatives, carbazole derivatives, and fluorene derivatives.

The low-molecular-weight compound luminous body can be roughly classified into two types: coloring matter type luminous bodies and metal complex type luminous bodies. Examples of the coloring matter type luminous bodies include cyclopentadiene derivatives, tetraphenylbutadiene derivatives, triphenylamine derivatives, oxadiazole derivatives, pyrrazoloquinoline derivatives, distyrylbenzene derivatives, distyrylarylene derivatives, silole derivatives, thiophene ring compounds, pyridine ring compounds, perynone derivatives, perylene derivatives, oligothiophene derivatives, trifumarylamine derivatives, an oxadiazole dimer, and a pyrazoline dimer. Examples of the metal complex type luminous bolides include an alumiquinolinol complex, a benzoquinolinol beryllium complex, a benzoxazole zinc complex, a benzothiazole zinc complex, anazomethyl zinc complex, aporphyrin zinc complex, europium complexes, and metal complexes which have as a central metal thereof aluminum, zinc, beryllium, or a rare metal such as terbium, europium or dysprosium and have as a ligand thereof an oxadiazole, thiadiazole, phenylpyridine, phenylbenzoimidazole or quinoline structure.

The pattern of the position, shape, image or the like of the luminous body can be recognized by radiating ultraviolet rays onto the luminous body to emit light, and detecting the pattern or spectrum of the emitted light with a CCD camera, a spectrometer or the like. The identification of a person can be performed by recognizing luminous positions of the dot pattern by use of coordinates and subjecting the results to data processing. For example, the person-verification can be performed by selecting sites which emit light inside the area surrounded by the bank, as illustrated in FIG. 2.

When the luminous body layer is irradiated with ultraviolet rays having a wavelength of 250 to 400 nm, the wavelength of the detected light is from about 400 to 800 nm. Since luminous bodies each have a unique spectrum, the determination of authenticity can be made more certain by recognizing the spectrum of light from the medium. A person-verifying medium of the invention having a unique spectrum is formed and then the spectrum is referred to, whereby misjudge can be decreased and the copying thereof can also be made difficult. Since the synthesis of any polymer compound luminous body is very difficult, the medium using the compound is easily prevented from being forged or altered. The spectrum can be inspected by a method of scanning all wavelengths in a specific range with a spectral sensitivity meter or the like and reading the spectrum. In the case of making effective use of a specific wavelength, the inspection can be conducted by use of a filter. In the case of using the sensitivity behavior of a light-receiving element such as a CCD camera, a pseudo spectrum can be detected using brightness and darkness or the like. The use of the filter makes it possible to cut unnecessary wavelengths from the light emission sites.

The following describes a case of using, for example, a luminous body having a broad light emission spectrum from 490 to 740 nm. In order to make light emission in the wavelength range of about 580 to 590 nm effective, light emission in a specific wavelength range can be recognized by inserting a filter into a CCD. Next, in order to specify the kind of the luminous body, two band-pass filters for wavelengths of 530 to 540 nm and for those of 580 to 590 nm are set up to halves of a CCD, respectively. One of the halves thereof detects light emission having wavelengths of 530 to 540 nm, and the other detects light emission having wavelengths of 580 to 590 nm. The emission intensity of each of the wavelength ranges is detected. From the ratio between the emission intensities, the kind of the luminous body can be specified. For example, in the case of a yellow luminous body, the ratio between the emission intensity at 530 to 540 nm and that at 580 to 590 nm is 4/5; and in the case of a blue luminous body, the ratio is 5/4. Since these are different, the used luminous body can be specified. When this method is used, the dot position of the luminous body and the kind thereof can be specified only with the CCD. Refer to FIG. 11.

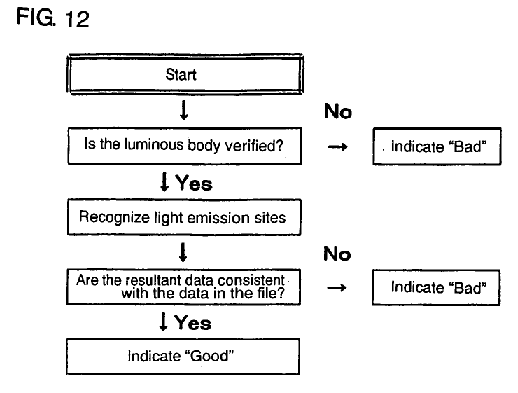

FIG. 12 shows a flowchart for recognizing the pattern of a person-verifying medium of the invention. By specifying the kind of a luminous body, recognizing the light emission sites thereof, and/or comparing the obtained data with data put in advance, person-identification can be attained and further the determination of forgery on alteration of the person-identification, as well as the determination of authenticity, can be made.

### EXAMPLES

### Example 1

(Formation of Bank) There were formed banks surrounding 4×4 dots (i.e., 4×4 square areas, which were each 0.3 mm×0.3 mm in size) at intervals of 0.3 mm. The thickness of the bank was 1 μm. When the thickness of a bank is about 1 μm, liquid droplets applied to inside of the bank by inkjet printing are precisely put to the insides of the bank without overflowing. By photolithography, the bank of 1 μm thickness, which was in a lattice form and made of polyimide, was formed. The photosensitive polyimide of the bank material was formed into a film by applying a solution of a precursor of the polyimide onto a glass substrate by spin coating while adjusting the rotation number to set the thickness of the film at 1 μm. Thereafter, the resultant was pre-baked on a hot plate at 100 degrees for 3 minutes, and then exposed to light. The exposure was conducted by radiation of y rays while patterning the film by using a photo-mask. Thereafter, the exposed regions were developed with a developer solution. As for the photosensitive polyimide, the exposed region reacted to be removed by the developer solution, and the regions shielded from the light with the light-shielding area of the mask remained. The resultant product was post-baked at 200 degrees for 3 minutes to convert the polyimide precursor to polyimide. The edge angle of the bank was determined by adjusting the post bake temperature or the like. In this example, the post bake temperature was set at 200 degrees; consequently, the edge angle was from 45 to 50 degrees.

(Formation of Luminous Layer)

Next, an inkjet printer was used to jet a 8.5 g/L solution of a poly(p-phenylenevinylene) derivative in anisole to the insides of the bank. The solution of the poly(p-phenylenevinylene) derivative, which is a luminous material, was diluted with anisole to adjust the viscosity thereof into 9 mPa·s. The ink was jetted out in an amount of 40 pL at each time from the inkjet printer head nozzles. The bank formed to set the inclination angle of its edge to 45 degrees was subjected to treatment for hydrophilicity and treatment for water repellency, so as to set the contact angle of the insides of the bank and that of the top of the bank to 10 degrees and 100 degrees, respectively. In this case, the ink was placed within the bank, and did not wet or spread to the top of the bank. When a bank is subjected to water repellency treatment and then coated with a luminous material by inkjet printing, printing or the like, the luminous material applied incorrectly to the top of the bank is pulled to the inside of the bank and placed only within the bank since the inside of the bank is made hydrophilic and the top of the bank is made water repellent. In the absence of any bank, the accuracy of the location where a luminous material is applied is as large as ±several tens of micrometers. The formation of a bank causes the location accuracy to be improved to ±several micrometers. When the luminous body can be applied with a high precision, the precision of the verification is more improved. Additionally, by making the pattern minute, forgery or alteration of the medium becomes significantly difficult.

(Formation of Organic Protective Film)

An ambient-temperature-curable epoxy resin (trade name: 2086M, manufactured by Three Bond) was used to laminate, by bar coating, a protective layer having a thickness of about 20 μm onto the luminous body film formed on the substrate, and then the resultant was sealed with a transparent polyester film (trade name: Lumilar (transliteration), manufactured by Toray ) or a cover glass. The application temperature of the adhesive and the drying temperature thereof were each set at 80 degrees. Ultraviolet rays having a broad wavelength band of about 250 to 400 nm were irradiated thereto, and deterioration of the luminous body was observed. In the case of using a transparent polyester film or the cover glass as the sealing material, the luminous material was hardly deteriorated even after continuous irradiation thereof with the ultraviolet rays for 5 hours. It appears that the epoxy resin alone has a sufficient sealing power. It is allowable to use, as the protective film made of an inorganic material, a film made of a metal oxide or a metal nitride such as aluminum nitride, aluminum oxide, silicon nitride, titanium oxide, silicon oxide, or silicon oxynitride.

### Example 2

A person-verifying medium was formed in the same way as in Example 1 except that aluminum was vapor-deposited, in a vacuum, onto the rear face of the substrate on which the luminous body layer was provided, so as to have a film of thickness of 100 nm (FIG. 4). Since the film of aluminum, which is a highly reflecting metal, was formed on the face opposite to the luminous body layer, the light emission intensity of the luminous body was remarkably raised.

### Example 3

As illustrated in FIG. 5, a bank made of polyamide, polyimide or the like was formed on a substrate in the same way as in Example 1. A film of a polymer compound luminous body was formed by inkjet printing. The used bank material was a polyamide material capable of being photo-lithographically worked. The bank sizes were each 0.3 mm square, and surrounded by the bank there were 32×64 dots.

### Example 4

8.5 grams of an organic luminous material, a poly(p-phenylenevinylene) was dissolved in anisole to adjust the viscosity thereof to 9 mPa·s. The solution was applied to form a monolithic film on a glass by inkjet printing or spin coating. The spin coating is a technique of jetting out the coating solution, as liquid droplets, from a nozzle exit onto the surface of the substrate, attaching the droplets onto the surface, and rotating the substrate to spread the coating solution attached to the substrate surface toward the edge of the substrate, thereby forming a thin film having an even thickness. The area where the film was formed was a 150 mm square. This was heated to 80 degrees on a hot plate, so as to form a poly(p-phenylenevinylene) thin film. Conditions for the inkjet printing or the rotation number of the substrate in the spin coating were set so as to make the film thickness of 80 nm. A laser ray was irradiated onto the thin film in a nitrogen atmosphere at a temperature of about the dew point −40 degrees. Even after the irradiation for 5 hours, the thin film was hardly deteriorated. Next, ultraviolet rays were irradiared onto the thin film in the atmosphere. In this case, the emission intensity was decreased in about several minutes, and reduced by half in about 30 minutes, so as to be attenuated. In the case of applying an epoxy resin onto the luminous body and then radiating ultraviolet rays onto the luminous body while protecting the body, the luminous body was hardly deteriorated in the same manner as in the nitrogen atmosphere. It is presumed from this fact that oxygen in the atmosphere was converted into oxygen radicals with the laser to deteriorate the luminous material. Next, a shadow mask of a metal was arranged on the front face of the luminous layer so that ultraviolet rays would be selectively irradiated. In this case also, the region shielded from the light with the metal mask was not deteriorated, and only the open region of the luminous layer was deteriorated. Such a simple shadow mask method makes it possible to attenuate the light from the luminous body selectively and cause the luminous body to have writing function.

In the case of irradiation by a YAG laser, the laser is intensely irradiated onto an organic material so as to denature the material by heat, whereby the light emitting capability of the material is lost to cause light-attenuation. On the other hand, in the case of ultraviolet rays, oxygen is converted into radicals by ultraviolet rays, whereby the material can be deteriorated; therefore, the substrate is not damaged. It appears that: according to the YAG laser irradiation, the organic layer is annealed, thereby causing the deterioration in the light emission performance of the luminous material; and according to the ultraviolet ray irradiation alone, the molecular structure itself does not change, but in the presence of oxygen the ultraviolet rays seem to cause oxygen to turn to radicals, whereby the molecular structure is changed to deteriorate the luminous body.

The YAG laser can have a wavelength of 266, 355, 532, 1064 nm or the like. The YAG laser having a wavelength of 532 nm or more does not produce any effect if the power thereof is not very large. On the other hand, according to the YAG laser having a wavelength of 355 nm, the light emitting capability can be deteriorated by the denaturation of the organic layer without producing any effect on the substrate. Thus, such YAG laser is preferred. Such light attenuation of the luminous material can be attained by irradiating a short-wavelength laser onto the person-verifying medium illustrated in FIG. 3 from the substrate 1 side and thus damaging the luminous body selectively. The laser may be in the form of pulses or continuous light. In the case of using a resin for the substrate, any YAG laser inflicts thermal damages to the substrate itself. Thus, ultraviolet rays are preferred. (Making Bank into Water Repellent State and Hydrophilic State) Six high-voltage electrodes, which were electrodes at one of opposite sides, were arranged in parallel at given intervals, and 6 low-voltage electrodes, which were electrodes at the other side, were arranged in parallel at given intervals in the same manner. The shape of the electrodes was made into a round bar form. By applying a voltage to the opposite electrodes across them, a gas introduced between the high-voltage electrodes and the low-voltage electrodes was ionized to generate atmospheric plasma. By means of a roller, the substrate was moved in a space between the high-voltage electrodes and the low-voltage electrodes so as to be moved through the generated plasma. The gas to be used for the plasma was introduced from an entrance port positioned above the electrodes and the gas used for the plasma was discharged from a discharge port. The voltage applied to the electrodes across them to generate the atmospheric plasma, which is sufficient to generate the plasma stably, was set to 5 kV in this example. The used power source was an AC power source and the frequency was set to 5 kHz. The voltage to be applied and the frequency thereof are not particularly limited if they cause the generation of the atmospheric plasma. Table 1 shows results obtained by measuring the hydrophilicity (contact angle) and the water repellency (contact angle) of a sample while changing the time when the atmospheric plasma was irradiated. The gas used for the atmospheric plasma was a mixed gas of argon, helium and oxygen, and the concentration of the oxygen, that of the argon and that of the helium were set to 10%, 45% and 45% by volume, respectively. As the substrate to be treated, a glass substrate 150 mm square was used. For water repellency treatment, a mixed gas of argon, helium and CF₄ was used as the gas introduced under the same conditions. The concentration of the CF4, that of the argon and that of the helium were set to 20%, 40% and 40% by volume, respectively. The wettability of the insides of the bank was from about 2 to 5 degrees, and that of the bank was from about 105 to 110 degrees. After the water repellency treatment was conducted continuously after the hydrophilicity treatment, the wettability of the insides of the bank was kept at about 5 degrees, and that of the bank was kept at about 100 degrees.

TABLE 1

| Hydrophilicity treatment | | Water repellency treatment | |
|---|---|---|---|
| Treating time | Contact angle | Treating time | Contact angle |
| (seconds) | (degrees) | (seconds) | (degrees) |
| Not treated | 20 | Not treated | 72 |
| 5 | 17 | 5 | 105 |
| 15 | 6 | 15 | 108 |
| 30 | 4 | 30 | 109 |

As described above, after the formation of the bank having water repellency, the luminous body was applied by the inkjet printing. The liquid droplets jetted out from the inkjet printer were evenly applied to the insides of the bank because of the inclination and the water repellency of the bank. In the absence of any bank, jetted-out liquid droplets, after landing, are subsequently extending outside so that a good precision cannot be obtained; however, the formation of a bank makes it possible to put liquid droplets precisely to the insides of the bank. The precision of the landing of the liquid droplets can be made into a high value of about ±5 μm.

In each of Examples 1 to 3, the mono-layered organic film was used as the protective film as illustrated in FIG. 3, but a mono-layered inorganic film or a hybrid film made of organic and inorganic films may be used. It is also allowable to laminate an organic film and an inorganic film or stick a plastic substrate together with an adhesive, as illustrated in FIGS. 6 to 8. In particular, in the laminate, which is composed of the organic and inorganic films, the use of the organic film as a stress-relieving layer for the inorganic film, which is easily cracked, makes it possible to suppress the deterioration of the luminous body remarkably. When a flexible material is used for the substrate, a sufficient strength against bending and so on can be given to the person-verifying medium. In the laminate composed of the organic and inorganic films, the number of the films can be selected at will if the transparency thereof is not damaged.

In each of Examples 1 to 3, the polymer compound luminous body was used, but a low-molecular-weight compound luminous body may be used. Low-molecular-weight materials cannot each be formed into a film from a solution wherein the material is dissolved in a solvent, which is different from polymers; therefore, any one of the materials is formed into a film by vacuum vapor deposition. The patterning of the film is performed by use of a shadow mask at the time of the vapor deposition.

Verification is performed by irradiating ultraviolet rays onto the luminous body by a information-reading device having an ultraviolet ray source, reading light rays emitted from the luminous body by a detector and the like, and analyzing the dot pattern or bar code pattern of the luminous body. The security of the medium can be made higher by detecting the emission spectrum thereof.

In particular, as for any polymer material, a high-level technique is necessary for the synthesis and the discretion of the selection of the combination of raw materials thereof is broad. Accordingly, it is hardly possible to copy a material having the same light emission spectrum. Therefore, the security is further improved. Besides, a pattern can be formed by combining luminous bodies in plural colors.

According to the present invention, a low-molecular-weight or polymer compound luminous body can be formed into a film with a high precision on a substrate in a wet step such as a vapor deposition or inkjet printing step. In the case of using inkjet printing, the precision in the patterning of the luminous body is about ±5 μm, and thus fine liquid droplets in the order of picoliters can be applied. When liquid droplets are dropped in the order of picoliters, light emission sites each having an area of several square micrometers can be obtained. Additionally, a dot pattern can be easily formed, and the pattern can be easily rendered a dot pattern which emits at random sites by use of an inkjet printing program. For example, in the case of forming a bank which surrounds 10×10 dots (areas) and applying a luminous body to dots which are arbitrarily selected, 2¹⁰⁰ patterns of information can be obtained in a very small area.

A large number of polymer compound luminous bodies are transparent when they are thin films. Thus, the card design is less restricted than conventional holograms or magnetic materials.

The patterned luminous body is excited or caused to emit light by ultraviolet rays, and detected as a pattern information, whereby a person is verified and the authenticity of the person-verifying medium is determined. When this pattern and the spectrum of the luminous body are detected, the precision in the authenticity determination is also raised, thereby making it possible to obtain a person-verifying medium which is not easily forged or altered. In particular, polymer material is more complicated in the production and structure thereof and is more difficult in copying thereof than low-molecular-weight material. This matter is combined with a technique wherein the material is made into a solution and the solution is precisely patterned, whereby the forgery or alteration becomes more difficult in the invention than in the prior art. When this method is used, the invention can be applied to broad fields of bank notes, gift certificates, credit cards and others, as well as person-verifying cards.

### INDUSTRIAL APPLICABILITY

The present invention relates to a technique for person-verification without disclosing person's information unnecessarily. In the case of performing verification of a person, in many cases the person has been hitherto verified by the input of an ID number or password. In recent years, person-verifying methods based on biological information have been increasing. In person-verifying methods based on biological information, it is necessary to store the fingerprint, iris or genetic information of a person, a photograph of his/her face, or other data in advance. There is a case where a purchase price in electronic commerce on the Internet is paid out through a credit card; it is necessary to input the number of the credit card, the expiration date thereof and others as the information for the payout. However, there arises a problem that even a third person can purchase a commodity if he/she knows the credit card number and the expiration date since the price thereof can be paid on the basis of only the credit number and the expiration date indicated on the card. Even if a credit card is used by the possessor thereof, the possessor needs to inform a salesperson of a shop about the card number and the expiration date so as to cause a considerable risk that the information of the possessor leak out.

Since a person-confirmation or person-verification system based on an ID number or a password depends on memorial capability of human beings, a risk that the data are deciphered or leak is sufficiently caused. The present invention is characterized by forming a luminous body into the form of a dot pattern. Since the luminous body cannot be easily observed with the naked eye, person's information cannot be simply obtained therefrom. The present invention has an advantage that the invention is not easily forged since the luminous body can be applied into the form of dots having a minimum diameter of 40 μm with a precision of ±5 μm. Such a pattern does not require a large area, and thus the formation thereof less restricts card design than the attachment of a hologram seal or the like. The pattern of the luminous body is read with a high precision with a CCD alone, whereby person's information can be obtained. Additionally, plural band-pass filters are used to detect the emission spectrum therefrom, whereby he kind of the luminous body can also be determined. Accordingly, the authenticity of the person-verifying medium of the invention can be determined. As described above, the person-verifying medium of the invention has wide industrial application.

What is claimed is:

1. A person-verifying medium, wherein there is provided on a substrate a luminous body layer in a dot pattern and being made of a material which does not emit light under visible rays but emits light under ultraviolet rays.

2. The person-verifying medium according to claim 1, wherein the luminous body layer in a dot pattern is formed in an area surrounded by a bank.

3. The person-verifying medium according to claim 2, wherein the bank has water repellency.

4. The person-verifying medium according to claim 2, wherein the area surrounded by the bank has hydrophilicity.

5. The person-verifying medium according to claim 2, wherein the form of the bank is a lattice form or an asymmetric matrix form.

6. The person-verifying medium according to claim 2, wherein the thickness of the bank is 0-10 μm larger than that of the luminous layer made of the luminous body.

7. The person-verifying medium according to claim 2, wherein the width of the top of the bank is from 1 to 5 μm.

8. The person-verifying medium according to claim 2, wherein the inclination angle of the bank is from 10 to 80 degrees.

9. The person-verifying medium according to claim 1 or 2, wherein a highly-reflecting metal film is formed beneath the luminous body layer.

10. The person-verifying medium according to claim 9, wherein the highly-reflecting metal film is a film made of a highly-reflecting metal selected from the group consisting of aluminum, silver, gold and chromium.

11. The person-verifying medium according to claim 1 or 2, wherein the substrate is a plastic substrate, a metal substrate or a glass substrate.

12. The person-verifying medium according to claim 1 or 2, wherein an organic film, an inorganic film or a laminated film made of an organic film and an inorganic film is provided, as a protective film layer, on the luminous body layer.

13. A process for producing a person-verifying medium, comprising the step of vapor-depositing a low-molecular-weight compound luminous body which does not emit light under visible rays but emits light under ultraviolet rays, thereby providing a luminous body layer in a dot pattern on a substrate.

14. A process for producing a person-verifying medium, comprising the step of forming a film by inkjet of a polymer compound luminous body which does not emit light under visible rays but emits light under ultraviolet rays, thereby providing a luminous body layer in a dot pattern on a substrate.

15. A process for producing a person-verifying medium, comprising the step of irradiating a luminous body layer with laser rays or ultraviolet rays to deteriorate the layer partially, thereby forming a luminous body layer in a dot pattern.

16. The process for producing a person-verifying medium according to claim 14, wherein: at the time of forming, on a substrate, a luminous body layer in a dot pattern of a luminous body, a bank is formed, on the substrate, in a lattice form according to claim 14, wherein: at the time of forming, on a substrate, a luminous body layer in a dot pattern of a luminous body, a bank is formed, on the substrate, in a lattice form or an asymmetric form; the bank is plasma-treated with a fluorine-based gas to impart water repellency to the bank; the area surrounded by the bank is subjected to irradiation with ultraviolet rays, ultraviolet ray/ozone treatment, or oxygen plasma treatment to impart hydrophilicity to the area; and a solution of a polymer compound luminous body is inkjet-printed in the hydrophilic area surrounded by the bank, thereby providing a dot pattern.

17. The process for producing a person-verifying medium according to claim 16, wherein the bank is formed by photolithography using a polyimide-based photoresist.

18. The process for producing a person-verifying medium according to any one of claims 13 to 16, wherein a highly-reflecting metal film is formed beneath the luminous body layer by one method selected from the group consisting of vacuum vapor deposition, sputtering and printing, using one metal selected from the group consisting of aluminum, silver, gold and chromium.

19. The process for producing a person-verifying medium according to any one of claims 13 to 16, wherein the substrate is a plastic substrate, a metal substrate or a glass substrate.
